(19) United States
(12) Patent Application Publication
(10) Pub. No.: US 2021/0388465 A1
(43) Pub. Date: Dec. 16, 2021

(54) MEMBRANE ELECTRODE MATERIAL, ITS PREPARATION METHOD AND APPLICATION IN LITHIUM EXTRACTION BY ADSORPTION-ELECTROCHEMICAL COUPLING TECHNOLOGY

(71) Applicant: Beijing University of Chemical Technology, Beijing (CN)

(72) Inventors: Xu XIANG, Beijing (CN); Ying SUN, Beijing (CN)

(21) Appl. No.: 17/347,035

(22) Filed: Jun. 14, 2021

(30) Foreign Application Priority Data
Jun. 15, 2020 (CN) 202010541034.7

(51) Int. Cl. C22B 26/12; C01G 45/02; C01D 15/08; C22B 7/00

(52) U.S. Cl. CPC C22B 26/12; C01G 45/02; C01D 15/08; C01P 2004/04; C01P 2006/40; C01P 2004/80; C01P 2002/72; C22B 7/006

(57) ABSTRACT

This invention provides a membrane electrode material and its preparation method, as well as the application of the material into lithium extraction by adsorption-electrochemical coupling method. The membrane electrode material is described as MnO@C. The preparation steps are as follows: LiMn₂O₄ is firstly obtained by calcining lithium carbonate and manganese carbonate, which is then dispersed in hydrochloric acid solution. After stirring and separating, the solid products are dried to obtain λ-MnO₂. The λMnO₂ is added to the raw material of Mn-MOF-74, and then the Mn-MOF-74 coated λ-MnO₂ can be obtained by hydrothermal reaction. By further calcining Mn-MOF-74 coated λ-MnO₂ in nitrogen atmosphere, the membrane capacitor/electrode material can be obtained as MnO@C. The material is fabricated into an adsorption film electrode plate and assembled into an adsorption-electrochemical coupling lithium extraction device. The pure lithium solution can be obtained in the recovery pool through the combined lithium extraction and lithium recovery process. In this invention, the thickness of the carbon coating layer in the electrode material is adjustable. Adsorption-electrochemical coupling technology takes the advantages of both adsorption and electrochemical lithium intercalation, which can extract and recover lithium resources with high capacity. Thus, this invention not only achieves high-efficiency separation of lithium resources, but also opens up a new way for the extraction of lithium resources.

### FIELD OF THE INVENTION

This invention belongs to the field of lithium resource separation and extraction, particularly involves a preparation method of membrane electrode material, and is application for the technology of lithium extraction from salt lake by adsorption-electrochemical coupling method.

### BACKGROUND OF THE INVENTION

Lithium is the first metal element in the periodic table of chemical elements, which is widely used in various fields. With the application of secondary batteries in electronic equipment, especially lithium-ion batteries are used to power the new energy electric vehicles, and thus the consumption of lithium resource in batteries is increasing, and batteries market accounts for more than half of the lithium usage. Recently, the demand for lithium-ion batteries has increased significantly, and the market demand for lithium resources also increases sharply, with an increase of 20% per year. China's lithium reserve is 4.5 million tons, in which salt lake brine lithium reserve accounts for more than 80%. Therefore, extraction of lithium from salt lake has gradually become a major way to obtain lithium resource.

China's salt lakes face the problems of high Mg/Li ratio and high Mg content, which makes the separation and extraction of Mg and Li take great challenges, resulting in the dependence of China's lithium resources on foreign countries reaching more than 80%. Once the import of Li resource is blocked, China's new energy industry, aerospace, nuclear energy and other related fields will be in trouble. Compared with magnesium ion, the content of lithium in salt lake brine in China is obviously lower. When the Mg/Li ratio is lower than 6, the chemical precipitation method can effectively separate lithium. However, high Mg/Li ratio means that simple chemical precipitation method cannot be used, because it will increase the loss of lithium and reduce the extraction rate of lithium. Thus, the biggest challenge of lithium recovery from salt lakes with high Mg/Li ratio is the efficient separation of Mg and Li. The magnesium and lithium are located in the diagonal position of the periodic table, and they are alkaline earth metals with similar chemical properties. Moreover, the radii of Mg and Li ions are very close, which are 72 and 76 pm respectively. Overall, it is very difficult to extract lithium from salt lake brine with high Mg/Li ratio.

The adsorption method is based on the specific selectivity principle of adsorbent to adsorb Li ion in brine, and then elute with dilute acid to obtain lithium rich solution. At present, aluminum salt adsorbent and ion sieve adsorbent are mostly studied. The process is simple and the recovery rate is high, but it is difficult to recover the adsorbent. With the increase of the use times, the ion channel is easy to be blocked, resulting in the reduced adsorption capacity, and the adsorbent will also dissolve in the acid treatment process.

Membrane capacitance desalination is a new ion separation technology, which solves the problem of dissolution loss of ion sieve based on manganese adsorbent. Membrane capacitor desalination has high desalting efficiency, electrode regeneration efficiency and energy utilization efficiency. Because cation and anion are in different areas during desalting and have regeneration links, such method avoids the accumulation of fouling. Lee et al. used LiMn₂O₄ as the membrane material, in which the adsorption capacity is 350 μmol/g, and the adsorption capacity is low (Lee D H. Selective lithium recovery from aqueous solution using a modified membrane capacitive deionization system. Hydrometallurgy, 2017, 173, 283-288). Siekierka et al. modified LiMn₂O₄ with TiO₂ doping, in which the adsorption capacity is significantly increased to 36.5 mg/g. Although it reaches the level of lithium extraction by adsorption method, it consumes additional power in this process (Siekierka A. Lithium dedicated adsorbent for the preparation of electrodes useful in the ion pumping method. Separation and Purification Technology, 2018, 194, 231-238). At present, the membrane capacitance technology is improved by process modification and lattice doping, but the lithium adsorption capacity is still rather low.

This invention designs membrane electrode materials from the aspects of both selective adsorption and electrochemical lithium intercalation, and proposes adsorption-electrochemical coupling technology. Manganese oxide coated with carbon (MnO@C) serves as a membrane electrode material, and the electron transfer to the MnO@C electrode surface upon applying voltage in the adsorption reaction; the lithium ion in the solution is attracted and embedded into the membrane electrode material for adsorption and electrochemical coupling reaction. A part of MnO adsorbs lithium ion in the lattice vacancy, and the other part of MnO is reduced to metal Mn by electrochemical reaction, accompanied by the formation of Li₂O. In the process of desorption reaction, lithium ion is desorbed from the lattice of MnO by applying reverse voltage, and the metal Mn is oxidized to MnO, and Li₂O reacts to form lithium ion. In this process, the MnO@C membrane electrode plays the roles of both selective adsorption of lithium ion and coupling with electrochemical reaction, which achieves efficient extraction of lithium resources.

### Content of the Invention

This invention aims to provide a membrane electrode material and its preparation method, which is used for extracting lithium by adsorption-electrochemical coupling technology.

The chemical composition of the membrane electrode material provided by this invention is MnO@C, in which the carbon is coated onto the surface of MnO. The thickness of carbon layer is 1-5 nm.

The detailed steps for the fabrication of membrane electrode material is as follows:

A. The lithium carbonate and manganese carbonate are mixed with the ratio of Li/Mn=0.1˜10, and after calcined at 30˜800° C. for 1˜8 h with the heating rate of 1˜10° C./min, LiMn₂O₄ can be prepared; LiMn₂O₄ is further dispersed in 0.1˜2 mol/L hydrochloric acid solution with the solid-liquid ratio of 1:10˜100; after stirred for 12˜48 h, solid products can be separated and dried to obtain λ-MnO₂;
B. MnCl₂·4H₂O and 2,5-dihydroxyterephthalic acid (DHTA) with the molar ratio of 1˜5:1 are dissolved in the mixed solvent, and the raw material solution is obtained by fully mixing;
The mixed solvent is prepared with X, ethanol and water with the volume ratio of (2˜20):1:1, wherein X is one or several mixed solutions of acetone, tetrahydrofuran, methanol and DMF;
C. The λ-MnO₂ in step A is added into the solution prepared in step B, with the solid content is 5˜50 g/L; after uniform mixing, the solution is then transferred to the reactor, and the reaction is conducted at 80° C.˜180° C. for 1˜48 h; upon cooling to room temperature, the suspension product is centrifuged and filtered; the filter product is washed with DMF solution for three times; at 4˜80° C., after drying for 3˜12 h, the Mn-MOF-74 coated λ-MnO₂ powder can be obtained;
D. The powder obtained in step C is further calcined in a tubular furnace under nitrogen atmosphere, with the temperature of 480° C.˜800° C. and the heating rate of 2˜10° C./min; the obtained product is carbon coated at the surface of MnO, described as MnO@C, in which the thickness of carbon layer is 1-5 nm. The MnO@C is further applied into the extraction of lithium by adsorption-electrochemical coupling method, which is as follows:

### (1) Preparation of Electrode Plate:

Preparation of activated carbon electrode plate: 0.5 g of activated carbon powder and 0.2 g of polyvinylidene fluoride are mixed; then, 5 mL of DMF is added to make a paste coating on the graphite plate; the plate is dried in vacuum oven at 50° C. overnight, and is fabricated into a 200 μm sheet using a roller press; Preparation of adsorption membrane electrode plate: 0.2 g of polyvinyl alcohol is dissolved into 4 mL of water; then, 0.5 g of MnO@C and 1 mL of glutaraldehyde are added to mix the paste, which is further coated onto the graphite plate and dried. After sprayed with HCl solution on the surface, the sample is dried in vacuum at 60° C. and pressed into a 200 μm sheet, as MnO@C membrane electrode plate.

(2) Assemble the Electrode Plate into the Lithium Extraction Device:

The film capacitor unit is assembled according to the order of organic glass plate (upper), adsorption membrane electrode plate, diaphragm, anion exchange membrane, activated carbon electrode plate and organic glass plate (lower), with the electrode area of 100 cm²;

The raw material pool, peristaltic pump, DC regulated power supply, membrane capacitor unit, conductivity meter, computer, test tank and recovery liquid pool are assembled to form an adsorption-electrochemical coupling lithium extraction device (as shown in FIG. 1). The raw material pool is connected with the inlet of the upper plate of the membrane capacitor unit through a peristaltic pump, and the outlet of the lower plate of the membrane capacitor unit is connected with the recovery liquid pool through the test tank; the probe of the conductivity meter is inserted into the test tank. The DC stabilized voltage power supply is connected with the membrane capacitor unit; the conductivity meter and DC stabilized voltage power supply are connected with the computer to set the condition parameters and store the test data.

### (3) Lithium Extraction Steps:

a. Lithium extraction process: the device runs with the applying voltage at 0.5˜2 V; the lithium solution in the raw material pool passes through the peristaltic pump to the membrane capacitor unit, and the lithium ion in the solution migrates to the adsorption membrane electrode plate and adsorbs onto the electrode; at the same time, the chloride ion migrates to the activated carbon electrode plate through the anion exchange membrane; the diaphragm hinders the short circuit of the positive and negative electrodes; the electrochemical reaction (in formula 1) occurs under the action of voltage; the conductivity increases with the extension of reaction time and tends to equilibrium gradually, that is, the adsorption capacity reaches the upper limit and the reaction ends; the solution flows back to the recovery liquid pool after reaction, where the lithium ion concentration decreases, and other ion concentrations remain basically unchanged, which can be returned to the raw material pool to continue lithium extraction;

The compositions of the lithium solution: Li⁺ concentration is 0.0˜100 g/L, Mg²⁺ concentration is 0.01˜100 g/L, K⁺ concentration is 0.01˜100 g/L, Na⁺ concentration is 0.01˜100 g/L, Cl⁻ concentration is 0.01˜100 g/L, SO₄²⁻ concentration is 0.01˜100 g/L;

b. Lithium recovery process: the deionized water is added into the raw material pool, and the device is operated with an opposite voltage of 0.5˜5 V, that is, the positive and negative electrodes are connected in reverse. The lithium ion adsorbed on the membrane electrode plate is desorbed into water, and the electrochemical reaction of the membrane electrode material (in formula 2) occurs; the conductivity decreases with the extension of operation time, and gradually tends to equilibrium, that is, lithium ion is completely removed from the adsorption electrode, and the reaction is finished; the recovery liquid pool is pure lithium solution, and the MnO@C can be obtained after evaporation and concentration. The product can be directly used to prepare battery-grade lithium carbonate.

MnO+2Li⁺+2e⁻→Mn⁰+Li₂O; Formula 1:

Mn⁰+Li₂O−2e⁻→MnO+2Li⁺. Formula 2:

FIG. 2 exhibits the (a) XRD and (b) HRTEM profiles of the membrane electrode materials in example 1, which shows the crystal phase of the carbon coated onto the surface of MnO, with the thickness of carbon layer of 1.59 nm.

FIG. 3 shows the change of lithium ion concentration in the test cell in example 1 for (a) lithium extraction process and (b) lithium recovery process. The adsorption capacity is 83.2 mg/g and the desorption rate is 96.4%.

The remarkable effect of the invention

The preparation of electrode material MnO@C is used to extract lithium from lithium containing solution by adsorption-electrochemical coupling method. The adsorption capacity of lithium is 83.0 mg/g and the removal rate is up to 96.1%. It realizes the efficient separation of lithium resources and provides an important way for the extraction of lithium resources. The thickness of the coated carbon electrode can be tunable effectively, which achieves a high capacity for the extraction and recovery of lithium resources using the adsorption-electrochemical coupling technology.

### DESCRIPTION OF THE FIGURES

FIG. 1 is the schematic diagram of lithium extraction device with adsorption-electrochemical coupling technology. (1). the raw material pool, (2). the peristaltic pump, (3). the DC regulated power supply, (4). the membrane capacitor unit, (5). the conductivity meter, (6). the computer, (7). the test tank, (8). the recovery liquid pool.

FIG. 2 is the characterization of the membrane electrode materials in example 1: FIG. 2 (a) XRD and FIG. 2(b) HRTEM profiles.

FIG. 3 is the change of lithium ion concentration in the test cell in example 1 for

FIG. 3(a) lithium extraction process and FIG. 3(b) lithium recovery process.

### DETAILED EXAMPLES

### Example 1

A. Weighting and mixing 2.9556 g of Li₂CO₃ and 18.392 g of MnCO₃ for calcination at 500° C. for 4 h with the heating rate of 3° C./min; LiMn₂O₄ is prepared; 2.7 g of LiMn₂O₄ is further dispersed in hydrochloric acid solution (120 mL, 0.5 mol/L); after stirred for 24 h, the solid products can be separated and dried to obtain λ-MnO₂;

B. Weighting 53 mL of DMF, 3.5 mL of ethanol and 3.5 mL of water to prepare the mixed solution. Weighing 2.198 g of MnCl₂·4H₂O and 0.6665 g of DHTA to dissolve them into the mixed solution to obtain the raw material solution of Mn-MOF-74.

C. Adding 1.5 g of λ-MnO₂ in step A into the 60 mL of Mn-MOF-74 raw material solution prepared in step B; after uniform mixing, the solution is then transferred to the reactor, and the reaction is conducted at 80° C. for 2 h; upon cooling to room temperature, the suspension product is centrifuged and filtered; the filter product is washed with DMF solution for three times; at 40° C., after drying for 12 h, the Mn-MOF-74 coated λ-MnO₂ powder can be obtained;

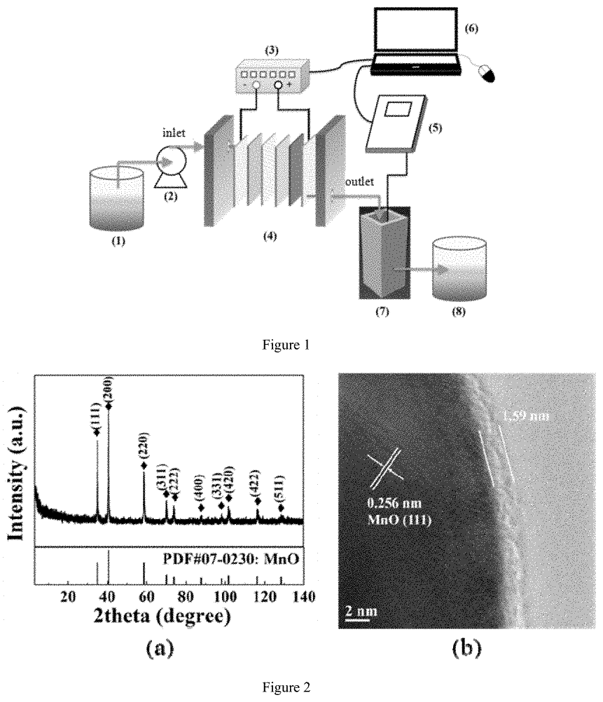

D. The powder obtained in step C is further calcined in a tubular furnace under nitrogen atmosphere, with the temperature of 480° C. and the heating rate of 10° C./min; the obtained product is carbon coated at the surface of MnO, described as MnO@C, in which the thickness of carbon layer is 1.59 nm. The XRD and HRTEM profiles for the MnO@C are shown in FIG. 2. MnO@C is further applied into the extraction of lithium by adsorption-electric coupling method, which is as follows:

### (1) Preparation of Electrode Plate:

Preparation of activated carbon electrode plate: 0.5 g of activated carbon powder and 0.2 g of polyvinylidene fluoride are mixed; then, 5 mL of DMF is added to make a paste coating on the graphite plate; the plate is dried in vacuum oven at 50° C. overnight, and is fabricated into a 200 μm sheet using a roller press; Preparation of adsorption membrane electrode plate: 0.2 g of polyvinyl alcohol is dissolved into 4 mL of water; then, 0.5 g of MnO@C and 1 mL of glutaraldehyde are added to mix the paste, which is further coated onto the graphite plate and dried. After sprayed with HCl solution on the surface, the sample is dried in vacuum at 60° C. and pressed into a 200 μm sheet, as MnO@C membrane electrode plate;

(2) Assemble the Electrode Plate into the Lithium Extraction Device:

The film capacitor unit is assembled according to the order of organic glass plate (upper), adsorption membrane electrode plate, diaphragm, anion exchange membrane, activated carbon electrode plate and organic glass plate (lower), with the electrode area of 100 cm²;

The raw material pool, peristaltic pump, DC regulated power supply, membrane capacitor unit, conductivity meter, computer, test tank and recovery liquid pool are assembled to form an adsorption-electrochemical coupling lithium extraction device based on the process in FIG. 1.

### (3) Lithium Extraction Steps:

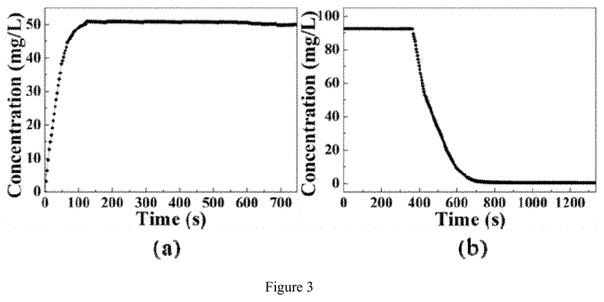

a. Lithium extraction process: the device runs with the applying voltage at 1.0 V; in the raw material pool, the concentrations are as follows: Li⁺:0.05 g/L, Mg²⁺:0.633 g/L, K⁺:0.1 g/L, Na⁺:2 g/L, Cl⁻:3.43 g/L; the solution in the raw material pool passes through the peristaltic pump to the membrane capacitor unit, and the lithium ion in the solution migrates to the adsorption membrane electrode plate and adsorbs onto the electrode. There is a small amount of lithium ion in the recovery liquid pool, which can be returned to the raw liquid to continue to extract lithium. The conductivity increases with the running time of the device, and gradually tends to equilibrium. The time to reach equilibrium is 123 s. Through the ICP test, the mass of lithium adsorption is 41.6 mg, and the adsorption capacity is 83.2 mg/g. The change of lithium ion concentration in the test tank during lithium extraction is shown in FIG. 3(a).

b. Lithium recovery process: the deionized water is added into the raw material pool, and the device is operated with an opposite voltage of 3.5 V, that is, the positive and negative electrodes are connected in reverse. The lithium ion adsorbed on the membrane electrode plate is desorbed into water. The recovery liquid pool is pure lithium solution. The conductivity decreases with the extension of operation time, and gradually tends to equilibrium. Through the ICP test, the mass of desorption lithium is 40.1 mg and the desorption rate is 96.4%. The change of lithium ion concentration in the test tank during lithium recovery is shown in FIG. 3(b).

### Example 2

A. Weighting and mixing 1.4778 g of Li₂CO₃ and 9.196 g of MnCO₃ for calcination at 550° C. for 5 h with the heating rate of 4° C./min; LiMn₂O₄ is prepared; 1.35 g of LiMn₂O₄ is further dispersed in hydrochloric acid solution (60 mL, 0.5 mol/L); after stirred for 26 h, the solid products can be separated and dried to obtain λ-MnO₂;

B. Weighting 26.5 mL of DMF, 1.8 mL of ethanol and 1.8 mL of water to prepare the mixed solution. Weighing 1.099 g of MnCl₂·4H₂O and 0.333 g of DHTA to dissolve them into the mixed solution to obtain the raw material solution of Mn-MOF-74.

C. Adding 1.5 g of λ-MnO₂ in step A into the 60 mL of Mn-MOF-74 raw material solution prepared in step B; after uniform mixing, the solution is then transferred to the reactor, and the reaction is conducted at 60° C. for 4 h; upon cooling to room temperature, the suspension product is centrifuged and filtered; the filter product is washed with DMF solution for three times; at 50° C., after drying for 10 h, the Mn-MOF-74 coated λ-MnO₂ powder can be obtained;

D. The powder obtained in step C is further calcined in a tubular furnace under nitrogen atmosphere, with the temperature of 530° C. and the heating rate of 10° C./min; the obtained product is carbon coated at the surface of MnO, described as MnO@C, in which the thickness of carbon layer is 2.86 nm. MnO@C is further applied into the extraction of lithium by adsorption-electric coupling method.

(1) Preparation of lectrode plate is the same as the example 1.

(2) Assemble the electrode plate into the lithium extraction device is the same as the example 1.

### (3) Lithium Extraction Steps:

a. Lithium extraction process: the device runs with the applying voltage at 1.2 V; in the raw material pool, the concentrations are as follows: Li⁺:0.11 g/L, Mg²⁺:1.39 g/L, K⁺:0.5 g/L, Na⁺:2.5 g/L, Cl⁻:4.87 g/L; the reaction time to reach equilibrium is 399 s. Through the ICP test, the mass of lithium adsorption is 25.4 mg, and the adsorption capacity is 50.8 mg/g.
b. Lithium recovery process: the deionized water is added into the raw material pool, and the device is operated with an opposite voltage of 2.5 V, that is, the positive and negative electrodes are connected in reverse. Through the ICP test, the mass of desorption lithium is 24.7 mg and the desorption rate is 97.4%.

### Example 3

A. Weighting and mixing 5.9112 g of Li₂CO₃ and 36.784 g of MnCO₃ for calcination at 600° C. for 6 h with the heating rate of 8° C./min; LiMn₂O₄ is prepared; 5.4 g of LiMn₂O₄ is further dispersed in hydrochloric acid solution (240 mL, 0.5 mol/L); after stirred for 36 h, the solid products can be separated and dried to obtain λ-MnO₂;

B. Weighting 106 mL of DMF, 7 mL of ethanol and 7 mL of water to prepare the mixed solution. Weighing 4.396 g of MnCl₂·4H₂O and 1.333 g of DHTA to dissolve them into the mixed solution to obtain the raw material solution of Mn-MOF-74.

C. Adding 1.5 g of λ-MnO₂ in step A into the 60 mL of Mn-MOF-74 raw material solution prepared in step B; after uniform mixing, the solution is then transferred to the reactor, and the reaction is conducted at 40° C. for 6 h; upon cooling to room temperature, the suspension product is centrifuged and filtered; the filter product is washed with DMF solution for three times; at 60° C., after drying for 8 h, the Mn-MOF-74 coated λ-MnO₂ powder can be obtained;

D. The powder obtained in step C is further calcined in a tubular furnace under nitrogen atmosphere, with the temperature of 580° C. and the heating rate of 10° C./min; the obtained product is carbon coated at the surface of MnO, described as MnO@C, in which the thickness of carbon layer is 3.01 nm. MnO@C is further applied into the extraction of lithium by adsorption-electric coupling method.

(1) Preparation of electrode plate is the same as the example 1.
(2) Assemble the electrode plate into the lithium extraction device is the same as the example 1.

### (3) Lithium Extraction Steps:

a. Lithium extraction process: the device runs with the applying voltage at 0.8 V; in the raw material pool, the concentrations are as follows: Li⁺:0.05 g/L, Mg²⁺:6.33 g/L, K⁺:1 g/L, Na⁺:3 g/L, Cl⁻:8.08 g/L; the reaction time to reach equilibrium is 387 s. Through the ICP test, the mass of lithium adsorption is 29.8 mg, and the adsorption capacity is 59.6 mg/g.
b. Lithium recovery process: the deionized water is added into the raw material pool, and the device is operated with an opposite voltage of 2.8 V, that is, the positive and negative electrodes are connected in reverse. Through the ICP test, the mass of desorption lithium is 28.8 mg and the desorption rate is 96.8%.

### Example 4

A. Weighting and mixing 4.4334 g of Li₂CO₃ and 27.588 g of MnCO₃ for calcination at 650° C. for 8 h with the heating rate of 10° C./min; LiMn₂O₄ is prepared; 4.05 g of LiMn₂O₄ is further dispersed in hydrochloric acid solution (180 mL, 0.5 mol/L); after stirred for 48 h, the solid products can be separated and dried to obtain λ-MnO₂;

B. Weighting 79.5 mL of DMF, 5.3 mL of ethanol and 5.3 mL of water to prepare the mixed solution. Weighing 3.297 g of MnCl₂·4H₂O and 0.999 g of DHTA to dissolve them into the mixed solution to obtain the raw material solution of Mn-MOF-74.

C. Adding 1.5 g of λ-MnO₂ in step A into the 60 mL of Mn-MOF-74 raw material solution prepared in step B; after uniform mixing, the solution is then transferred to the reactor, and the reaction is conducted at 100° C. for 2 h; upon cooling to room temperature, the suspension product is centrifuged and filtered; the filter product is washed with DMF solution for three times; at 50° C., after drying for 12 h, the Mn-MOF-74 coated λ-MnO₂ powder can be obtained;

D. The powder obtained in step C is further calcined in a tubular furnace under nitrogen atmosphere, with the temperature of 630° C. and the heating rate of 10° C./min; the obtained product is carbon coated at the surface of MnO, described as MnO@C, in which the thickness of carbon layer is 3.59 nm. MnO@C is further applied into the extraction of lithium by adsorption-electric coupling method.

(1) Preparation of electrode plate is the same as the example 1.
(2) Assemble the electrode plate into the lithium extraction device is the same as the example 1.

### (3) Lithium Extraction Steps:

a. Lithium extraction process: the device runs with the applying voltage at 1.1 V; in the raw material pool, the concentrations are as follows: Li⁺:1.5 g/L, Mg²⁺:18.99 g/L, K⁺:1.5 g/L, Na⁺:5 g/L, Cl⁻:16.73 g/L; the reaction time to reach equilibrium is 123 s. Through the ICP test, the mass of lithium adsorption is 31.6 mg, and the adsorption capacity is 63.2 mg/g.
b. Lithium recovery process: the deionized water is added into the raw material pool, and the device is operated with an opposite voltage of 3.5 V, that is, the positive and negative electrodes are connected in reverse. Through the ICP test, the mass of desorption lithium is 30.1 mg and the desorption rate is 95.3%.

### Example 5

A. Weighting and mixing 5.172 g of Li₂CO₃ and 32.186 g of MnCO₃ for calcination at 500° C. for 4 h with the heating rate of 3° C./min; LiMn₂O₄ is prepared; 4.725 g of LiMn₂O₄ is further dispersed in hydrochloric acid solution (204 mL, 0.5 mol/L); after stirred for 24 h, the solid products can be separated and dried to obtain λ-MnO₂;

B. Weighting 90 mL of DMF, 6 mL of ethanol and 6 mL of water to prepare the mixed solution. Weighing 3.737 g of MnC12.4H20 and 1.133 g of DHTA to dissolve them into the mixed solution to obtain the raw material solution of Mn-MOF-74.

C. Adding 1.5 g of λ-MnO₂ in step A into the 60 mL of Mn-MOF-74 raw material solution prepared in step B; after uniform mixing, the solution is then transferred to the reactor, and the reaction is conducted at 120° C. for 1 h; upon cooling to room temperature, the suspension product is centrifuged and filtered; the filter product is washed with DMF solution for three times; at 50° C., after drying for 12 h, the Mn-MOF-74 coated λ-MnO₂ powder can be obtained;

D. The powder obtained in step C is further calcined in a tubular furnace under nitrogen atmosphere, with the temperature of 530° C. and the heating rate of 10° C./min; the obtained product is carbon coated at the surface of MnO, described as MnO@C, in which the thickness of carbon layer is 4.857 nm. MnO@C is further applied into the extraction of lithium by adsorption-electric coupling method.

(1) Preparation of electrode plate is the same as the example 1.
(2) Assemble the electrode plate into the lithium extraction device is the same as the example 1.

### (3) Lithium Extraction Steps:

a. Lithium extraction process: the device runs with the applying voltage at 1.1 V; in the raw material pool, the concentrations are as follows: Li⁺:1.5 g/L, Mg²⁺:19.99 g/L, K⁺:1.5 g/L, Na⁺:5 g/L, Cl⁻:16.73 g/L; the reaction time to reach equilibrium is 270 s. Through the ICP test, the mass of lithium adsorption is 35.7 mg, and the adsorption capacity is 71.4 mg/g.
b. Lithium recovery process: the deionized water is added into the raw material pool, and the device is operated with an opposite voltage of 3.5 V, that is, the positive and negative electrodes are connected in reverse. Through the ICP test, the mass of desorption lithium is 34.4 mg and the desorption rate is 96.5%.

1. A preparation method for the membrane electrode material is characterized in the steps as follows:
A. The lithium carbonate and manganese carbonate are mixed with the ratio of Li/Mn=0.1˜10. and after calcined at 300˜800° C. for 1˜8 h with the heating rate of 1˜10° C./min, LiMn₂O₄ can be prepared; LiMn₂O₄ is further dispersed in 0.1˜2 mol/L hydrochloric acid solution with the solid-liquid ratio of 1:10˜100; after stirring for 12˜48 h, solid products can be separated and dried to obtain λ-MnO₂;
B. MnCl₂·4H₂O and 2,5-dihydroxyterephthalic acid (DHTA) with the molar ratio of 1˜5:1 are dissolved in the mixed solvent, and the raw material solution is obtained by fully mixing;
The mixed solvent is prepared with X, ethanol and water with the volume ratio of (2˜20)1:1, wherein X is one or several mixed solutions of acetone, tetrahydrofuran, methanol and N, N-dimethylformamide (DMF);
C. The λ-MnO₂ in step A is added into the solution prepared in step B, with the solid content is 5˜50 g/L; after uniform mixing, the solution is then transferred to the reactor, and the reaction is conducted at 80° C.˜180° C. for 1˜48 h; upon cooling to room temperature, the suspension product is centrifuged and filtered; the filter product is washed with DMF solution for three times; at 40˜80° C., after drying for 3˜12 h, the Mn-MOF-74 coated λ-MnO₂ powder can be obtained;
D. The powder obtained in step C is further calcined in a tubular furnace under nitrogen atmosphere, with the temperature of 480° C.˜800° C. and the heating rate of 2˜10° C./min; the obtained product is carbon coated at the surface of MnO, described as MnO@C, in which the thickness of carbon layer is 1-5 nm.

2. A membrane electrode material is prepared by the method according to claim 1, and its chemical expression can be described as MnO@C, in which the carbon is coated at the surface of MnO, and the thickness of carbon layer is 1-5 nm.

3. The membrane electrode material in claim 2 can be applied into the extraction of lithium by adsorption-electric coupling method, which is as follows:
(1) Preparation of electrode plate:
Preparation of activated carbon electrode plate: 0.5 g of activated carbon powder and 0.2 g of polyvinylidene fluoride are mixed; then, 5 mL of DMF is added to make a paste coating on the graphite plate; the plate is dried in vacuum oven at 50° C. overnight, and is fabricated into a 200 μm sheet using a roller press;
Preparation of adsorption membrane electrode plate: 0.2 g of polyvinyl alcohol is dissolved into 4 mL of water; then, 0.5 g of MnO@C and 1 mL of glutaraldehyde are added to mix the paste, which is further coated onto the graphite plate and dried. After sprayed with HCl solution on the surface, the sample is dried in vacuum at 60° C. and pressed into a 200 μm sheet, as MnO@C membrane electrode plate;
(2) Assemble the electrode plate into the lithium extraction device:
The film capacitor unit is assembled according to the order of organic glass plate (upper), adsorption membrane electrode plate, diaphragm, anion exchange membrane, activated carbon electrode plate and organic glass plate (lower), with the electrode area of 100 cm²;
The raw material pool, peristaltic pump, DC regulated power supply, membrane capacitor unit, conductivity meter, computer, test tank and recovery liquid pool are assembled to form an adsorption-electrochemical coupling lithium extraction device. Specifically, the raw material pool is connected with the inlet of the upper plate of the membrane capacitor unit through a peristaltic pump, and the outlet of the lower plate of the membrane capacitor unit is connected with the recovery liquid pool through the test tank; the probe of the conductivity meter is inserted into the test tank. The DC stabilized voltage power supply is connected with the membrane capacitor unit; the conductivity meter and DC stabilized voltage power supply are connected with the computer to set the condition parameters and store the test data;
(3) Lithium extraction steps:
a. Lithium extraction process: the device runs with the applying voltage at 0.5-2 V; the lithium solution in the raw material pool passes through the peristaltic pump to the membrane capacitor unit, and the lithium ion in the solution migrates to the adsorption membrane electrode plate and adsorbs onto the electrode; at the same time, the chloride ion migrates to the activated carbon electrode plate through the anion exchange membrane; the diaphragm hinders the short circuit of the positive and negative electrodes; the electrochemical reaction (in formula 1) occurs under the action of voltage; formula 1:
MnO+2Li⁺+2e⁻→Mn⁰+Li₂O;
The conductivity increases with the extension of reaction time and tends to equilibrium gradually, that is, the adsorption capacity reaches the upper limit and the reaction ends; the solution flows back to the recovery liquid pool after reaction, where the lithium ion concentration decreases, and other ion concentrations remain basically unchanged, which can be returned to the raw material pool to continue lithium extraction;
The compositions of the lithium solution: Li⁺ concentration is 0.0˜100 g/L, Mg²⁺ concentration is 0.01˜100 g/L, K⁺ concentration is 0.01˜100 g/L, Na⁺ concentration is 0.01˜100 g/L, Cl⁻ concentration is 0.01˜100 g/L, SO₄²⁻ concentration is 0.01˜100 g/L;
b. Lithium recovery process: the deionized water is added into the raw material pool, and the device is operated with an opposite voltage of 0.5˜5 V, that is, the positive and negative electrodes are connected in reverse. The lithium ion adsorbed on the membrane electrode plate is desorbed into water, and the electrochemical reaction of the membrane electrode material (in formula 2) occurs; formula 2:
Mn⁰+Li₂O−2e⁻→MnO+2Li⁺.
The conductivity decreases with the extension of operation time, and gradually tends to equilibrium, that is, lithium ion is completely removed from the adsorption electrode, and the reaction is finished; the recovery liquid pool is pure lithium solution, and the MnO@C can be obtained after evaporation and concentration. The product can be directly used to prepare battery-grade lithium carbonate.
